(19) United States
(12) Patent Application Publication
(10) Pub. No.: US 2017/0091201 A1
(43) Pub. Date: Mar. 30, 2017

(54) DYNAMIC CLASSIFICATION OF DIGITAL FILES

(71) Applicant: Longsand Limited, Cambridge (GB)

(72) Inventors: Jerry Philip Chabot, Shrewsbury, MA (US); Curtis William Warner, Rochdale, MA (US); Joseph S. Ficara, Shrewsbury, MA (US)

(21) Appl. No.: 14/871,627

(22) Filed: Sep. 30, 2015

(51) Int. Cl. G06F 17/30

(52) U.S. Cl. CPC G06F 17/30082; G06F 17/3012

(57) ABSTRACT

A computing device includes at least one processor and a machine-readable storage medium storing instructions. The instructions may be executable by the hardware processor to detect an action to share a first file of the plurality of unclassified files with a second user, where the plurality of unclassified files are owned by a first user. The instructions are also executable to, in response to a detection of the action: identify a set of classification rules associated with the second entity; classify the first file using the set of classification rule to obtain a classified file and classification metadata; and store the classification metadata.

### BACKGROUND

Some computing systems enable users to create and store various types of digital files. For example, such digital files may include text documents, digital photographs, digital videos, sound recordings, spreadsheets, databases, social media content, emails, and so forth. Further, some computing systems may enable users to access the stored digital files using various devices. For example, a user may access stored files using a desktop computer, a tablet, a laptop, a mobile telephone, a smart watch, or any similar devices.

### BRIEF DESCRIPTION OF THE DRAWINGS

Some implementations are described with respect to the following figures.

FIG. 1 is a schematic diagram of an example computing device, in accordance with some implementations.

FIG. 2 is a schematic diagram of an example system in accordance with some implementations.

FIG. 3 is an illustration of an example digital file according to some implementations.

FIG. 4 is a flow diagram of an example file classification process in accordance with some implementations.

FIG. 5 is a flow diagram of an example file classification process in accordance with some implementations.

FIG. 6 is a flow diagram of an example file reclassification process in accordance with some implementations.

FIG. 7 is a schematic diagram of an example computing device, in accordance with some implementations.

FIG. 8 is a schematic diagram of an example machine-readable storage medium storing instructions in accordance with some implementations.

### DETAILED DESCRIPTION

File management systems allow users to store digital files in a data repository (e.g., “cloud” storage), and to access those files from remote devices. Such file management systems can also allow users to share their files with other users. Conventionally, digital files are classified at the time that they are stored in a file management system. As used herein, “classification” refers to the process of analyzing the contents of a digital file to determine classes or categories that apply to that digital file. The classification information for a file is stored for later use. Further, the classification of each file requires some amount of processing by the computer system. As such, classifying all files when included in the file management system can require a large amount of storage space to store the corresponding classification information, as well as substantial processing loads to perform the classification of all files.

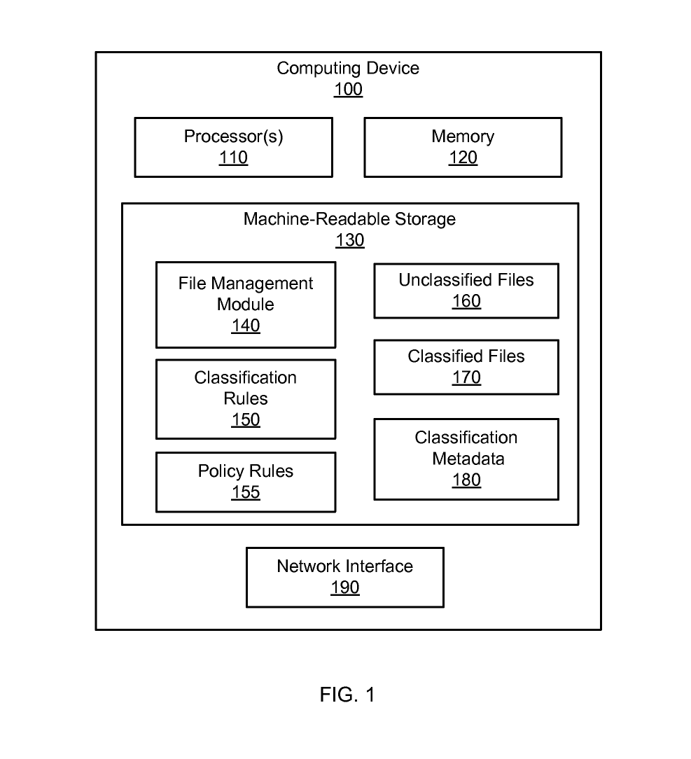

In accordance with some implementations, techniques or mechanisms are provided for dynamic classification of digital files in a file management system. As described further below with reference to FIGS. 1-8, some implementations may include storing all digital files in unclassified form (i.e., without performing classification). Subsequently, if a triggering event associated with a particular file occurs, that file may be classified in response to the event (referred to herein as “dynamic classification”). This classification may result in a classified file and classification metadata. The classification metadata can be stored in the file management system. In some implementations, the storage space and processing load required for classification may be reduced in comparison to conventional file management systems.

FIG. 1 is a schematic diagram of an example computing device 100, in accordance with some implementations. The computing device 100 may be, for example, a computer, a portable device, a server, a network device, a communication device, etc. Further, the computing device 100 may be any grouping of related or interconnected devices, such as a blade server, a computing cluster, and the like. Furthermore, in some implementations, the computing device 100 may correspond to all or a portion of a file management system.

As shown, the computing device 100 can include processor(s) 110, memory 120, machine-readable storage 130, and a network interface 190. The processor(s) 110 can include a microprocessor, microcontroller, processor module or subsystem, programmable integrated circuit, programmable gate array, multiple processors, a microprocessor including multiple processing cores, or another control or computing device. The memory 120 can be any type of computer memory (e.g., dynamic random access memory (DRAM), static random-access memory (SRAM), etc.).

The network interface 190 can provide inbound and outbound network communication. The network interface 190 can use any network standard or protocol (e.g., Ethernet, Fibre Channel, Fibre Channel over Ethernet (FCoE), Internet Small Computer System Interface (iSCSI), a wireless network standard or protocol, etc.). Further, network interface 190 can provide communication with remote computing devices (not shown).

In some implementations, the machine-readable storage 130 can include non-transitory storage media such as hard drives, flash storage, optical disks, etc. As shown, the machine-readable storage 130 can include a file management module 140, classification rules 150, policy rules 155, unclassified files 160, classified files 170, and classification metadata 180.

In some implementations, the file management module 140 can perform and/or control various processes of a file management system. For example, the file management module 140 may control the addition and deletion of digital files to/from the file management system. Further, the file management module 140 may control synchronization, backup, encryption, replication, sharing, auditing, and/or collaboration of digital files. The file management module 140 can receive and process user data and commands for file management.

In some implementations, the file management module 140 can receive digital files to be included in a file management system. Further, the file management module 140 can store any received digital files as unclassified files 160. As used herein, “unclassified file” refers to a file that is stored without performing a classification of that file. For example, the file management module 140 can store all digital files received from a user (or multiple users) without determining any classification information for those digital files. Examples of digital files may include text documents, digital photographs, digital videos, electronic books and articles, sound recordings, spreadsheets, folders, databases, social media content, emails, archives, compound files, applications, and so forth.

In some implementations, the file management module 140 performs dynamic classification in response to events associated with digital files. As used herein, “triggering event” refers to an event or action that affects access to an unclassified file. For example, the file management module 140 can detect actions and/or commands to share or collaborate on a digital file with a particular user or group of users (referred to as “sharing events”). In response to detecting a sharing event for a particular file included in the unclassified files 160, the file management module 140 can perform a classification of that file. Further, the file management module 140 can perform a classification in response to a file being set or flagged for an automated file management action (e.g., backup, retention, synchronization, encryption, replication, restoration, and so forth). Furthermore, the file management module 140 can perform a classification in response to a change in user group or permissions for an owner of a file. In addition, the file management module 140 can perform a classification in response to a file being accessed by a particular device or a type of device. The classified files 170 shown in FIG. 1 may represent files that have been classified by the file management module 140 in response to triggering events.

In some implementations, the file management module 140 can classify a digital file using the classification rules 150. The classification rules 150 can specify classes or types based on content and/or characteristics of a file. For example, the classification rules 150 can identify predefined sequences of characters or words in a file, and can associate the sequences with different classes or types. The classification rules 150 may specify a classification tag to identify the content of a file (e.g., business reports, financial disclosures, identification information, confidential medical information, workgroup type, personal information, social security information, banking information, credit card information, and so forth). In some implementations, the classification rules 150 can be based on other content or characteristics of a file, such as image content, video content, audio content, semantic content, topics, file size, creation time, file name, file owner, file permissions, and so forth.

In some implementations, the file management module 140 can determine which classification rules 150 are applicable to classify a digital file. The classification rules 150 can be associated with specific entities or entity types. As used herein, the term “entity” may refer to an individual user, a type of user, a group, a distribution list, an organization, a company, a device, and so forth. For example, a classification rule 150 may be applicable to a specific type of user of the file management system (e.g., guest, administrator, super-user, owner, employee, partner, client, etc.). In another example, a classification rule 150 may be applicable to members of a particular group or organization (e.g., workgroup, email distribution list, division, company, partnership, general public, customer list, and so forth). In yet another example, a classification rule 150 may be applicable to a specific device or type of device (e.g., mobile device, stationary device, encrypted device, etc.). In some implementations, the file management module 140 can determine which classification rules 150 are applicable to a classification based on an email domain of the entity that is to receive access to the file and/or an email domain of the file owner.

In some implementations, the file management module 140 can generate classification metadata 180 during the classification of digital files. For example, the classification metadata 180 can include classification tags specifying any classes that are identified during the classification of a digital file. Further, in some implementations, the classification metadata 180 can include content portions and/or characteristics of a file that triggered a classification rule. For example, the classification metadata 180 can include text portions of a digital file, file characteristics, and so forth. In some implementations, all or a portion of the classification metadata 180 may be encrypted to secure confidential or sensitive information included in the portions and/or characteristics that triggered the classification rule. In some implementations, the classification rules 150, the unclassified files 160, the classified files 170, and/or the classification metadata 180 may be stored in a database or other data structure (e.g., a relational database, an object database, an extensible markup language (XML) database, a flat file, and so forth). Further, in some implementations, the classification metadata 180 may be stored in a metadata repository.

In some implementations, the file management module 140 can determine which classification rules 150 are applicable to a classification based on the policy rules 155. In some implementations, the policy rules 155 may specify the triggering events for dynamic classification. For example, the policy rules 155 may specify that a classification is performed in response to sharing events, to setting a file for backup or retention, to a change in a user group, to access to a file by a user, to access to a file by a device, and so forth. Further, the policy rules 155 may specify which classification rules 150 are applicable to a particular classification. For example, the policy rules 155 may specify the applicable classification rules 150 based on the characteristics of the file, characteristics of the file owner, characteristics of the entity that is to receive access to the file, characteristics of a device accessing the file, and so forth.

In some implementations, the policy rules 155 can specify the behaviors or actions that are permitted for a file with a particular classification. For example, the policy rules 155 may specify which groups or types of users can access and/or modify files with a given classification. Further, the policy rules 155 may specify whether files with a given classification can be shared or collaborated on, can be remotely accessed, can be backed up, and so forth.

In some implementations, the classification of a digital file may be performed asynchronously to a triggering event. For example, after being triggered to perform a classification, the file management module 140 may perform the classification as a low-priority background job that executes when the computing device 100 has unused processing capacity.

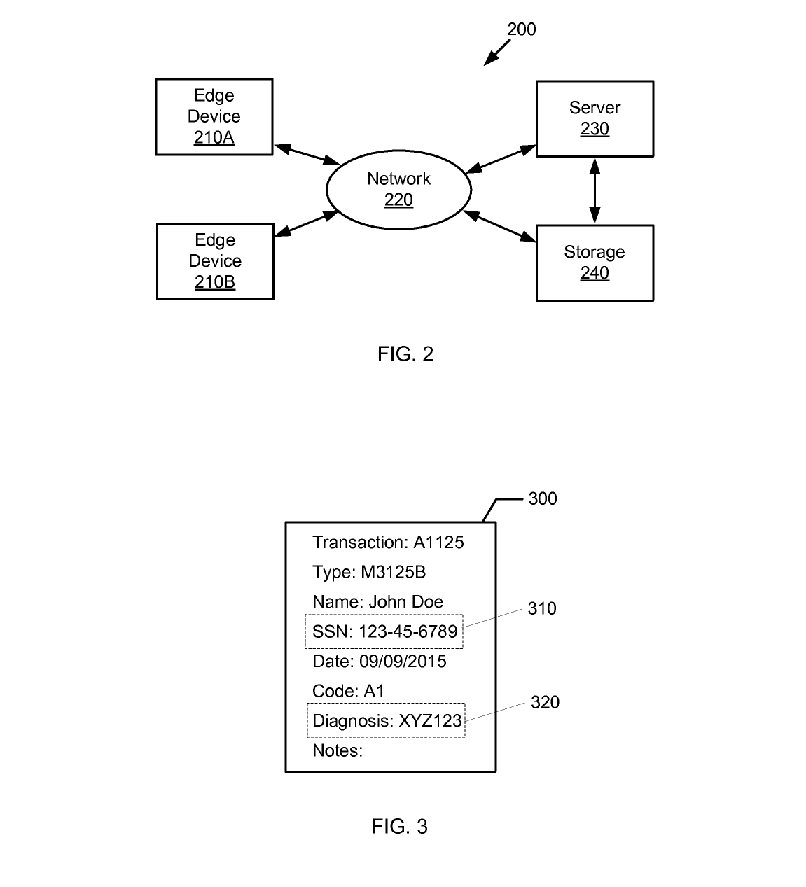

Various aspects of the file management module 140, the classification rules 150, the policy rules 155, the unclassified files 160, the classified files 170, and the classification metadata 180 are discussed further below with reference to FIGS. 2-8. Note that any of these aspects can be implemented in any suitable manner. For example, any of these aspects can be implemented in multiple devices. Further, in some examples, the file management module 140 can be hard-coded as circuitry included in the processor(s) 110 and/or the computing device 100. Furthermore, in other examples, the file management module 140 can be implemented as machine-readable instructions included in the machine-readable storage 130.

Referring now to FIG. 2, shown is an example of a file management system 200, in accordance with some implementations. As shown, the file management system 200 can include a server 230, storage 240, and various edge devices 210A, 210B connected by a network 220. In some implementations, some or all of the devices included in the file management system 200 can correspond to the computing device 100 shown in FIG. 1. For example, some or all of the file management module 140 may be implemented in the server 230, the storage 240, and the edge devices 210A, 210B, or any combination thereof In another example, some or all of the classification rules 150, the unclassified files 160, the classified files 170, and/or the classification metadata 180 may be included in the server 230, the storage 240, and the edge devices 210A, 210B, or any combination thereof It is contemplated that other combinations and/or variations are also possible.

Referring now to FIG. 3, shown is an example of a digital file 300, in accordance with some implementations. As shown, the digital file 300 is a document including various written text portions. Assume that the digital file 300 is classified using a first classification rule directed to social security information and a second classification rule directed to confidential medical information. Assume further that the first classification rule is triggered by the text string “SSN” included in the first text portion 310. As such, in this example, the first classification rule may generate a first classification tag to indicate that the digital file 300 includes social security information. Further, the first text portion 310 may be stored along with the first classification tag and/or the digital file 310.

Assume further that the second classification rule is triggered by the text string “DIAGNOSIS” included in the second text portion 320. As such, in this example, the second classification rule may generate a second classification tag to indicate that the digital file 300 includes confidential medical information. Further, the second text portion 320 may be stored along with the second classification tag and/or the digital file 310. It should be noted that the digital file 300 shown in FIG. 3 is an example, and does not limit any implementations.

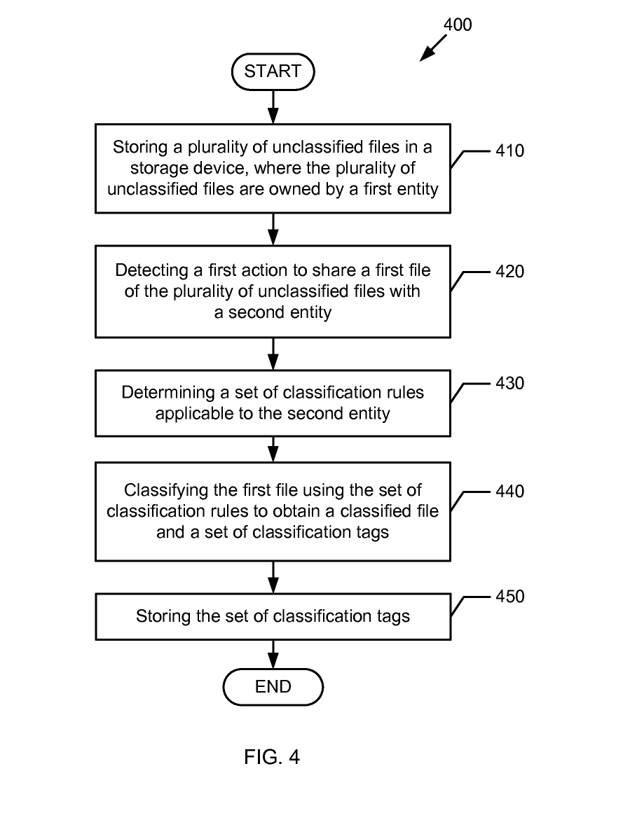

Referring now to FIG. 4, shown is a process 400 for dynamic classification of digital files, in accordance with some implementations. The process 400 may be performed by the processor(s) 110 and/or the file management module 140 shown in FIG. 1. The process 400 may be implemented in hardware or machine-readable instructions (e.g., software and/or firmware). The machine-readable instructions are stored in a non-transitory computer readable medium, such as an optical, semiconductor, or magnetic storage device. For the sake of illustration, details of the process 400 may be described below with reference to FIGS. 1-3, which show examples in accordance with some implementations. However, other implementations are also possible.

As shown, block 410 includes storing a plurality of unclassified files in a storage device, where the plurality of unclassified files are owned by a first entity. For example, referring to FIG. 1, the file management module 140 may store received digital files in the unclassified files 160. In some implementations, each of the unclassified files 160 is classified only in response to an triggering event or action associated with that file.

Block 420 includes detecting a first action to share a first file of the plurality of unclassified files with a second entity. For example, referring to FIG. 1, the file management module 140 may detect a first user sharing a first file with a second user. In another example, the file management module 140 may detect the first user enabling collaboration of the first file with a group of users.

Block 430 includes determining a set of classification rules applicable to the second entity. For example, referring to FIG. 1, in response to detecting the first user sharing the first file with the second user, the file management module 140 can identify a subset of the classification rules 150 that apply to the second user. In some implementations, the file management module 140 can determine which classification rules 150 are applicable based on the policy rules 155.

Block 440 includes classifying the first file using the set of classification rules to obtain a classified file and a set of classification tags. For example, referring to FIG. 1, the file management module 140 may classify the first file using the subset of the classification rules 150 that apply to the second user. This classification can generate a classified file and a set of corresponding classification tags.

Block 450 includes storing the set of classification tags. For example, referring to FIG. 1, the file management module 140 may cause the set of classification tags to be stored or otherwise included in the classification metadata 180. In some implementations, the classification metadata 180 may be stored in a database, a repository, a file, or other data structure. After block 450, the process 400 is completed.

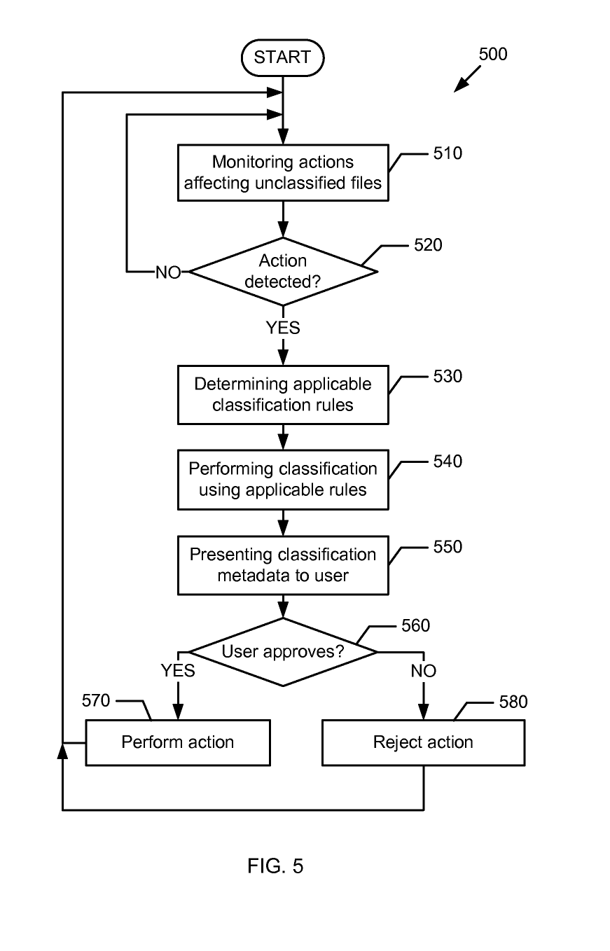

Referring now to FIG. 5, shown is a process 500 for dynamic classification of digital files, in accordance with some implementations. The process 500 may be performed by the processor(s) 110 and/or the file management module 140 shown in FIG. 1. The process 500 may be implemented in hardware or machine-readable instructions (e.g., software and/or firmware). The machine-readable instructions are stored in a non-transitory computer readable medium, such as an optical, semiconductor, or magnetic storage device. For the sake of illustration, details of the process 500 may be described below with reference to FIGS. 1-3, which show examples in accordance with some implementations. However, other implementations are also possible.

As shown, block 510 includes monitoring actions affecting unclassified files. For example, referring to FIG. 1, the file management module 140 may monitor actions that affect access to an unclassified file 160. In some implementations, the actions may be specified by the policy rules 155.

Block 520 includes a determination about whether an action affecting an unclassified file was detected. For example, referring to FIG. 1, the file management module 140 may determine whether an action affecting a first file has been detected. If it is determined at block 520 that an action affecting an unclassified file was not detected, then the process 500 can return to block 510. However, if it is determined at block 520 that an action affecting an unclassified file was detected, then the process 500 continues to block 530. For example, referring to FIG. 1, the file management module 140 may detect a first user sharing a first file with a second user.

Block 530 includes determining applicable classification rules. For example, referring to FIG. 1, the file management module 140 can identify a subset of the classification rules 150 that are applicable (e.g., rules that apply to the first file, the first user, and/or the second user). In some implementations, the file management module 140 can determine which classification rules 150 are applicable based on the policy rules 155.

Block 540 includes performing a classification using the applicable rules. For example, referring to FIG. 1, the file management module 140 may classify the first file using the applicable subset of the classification rules 150. In some implementations, performing the classification can result in classification results including a classified file 170 and classification metadata 180.

Block 550 includes presenting the classification metadata to a user. For example, referring to FIG. 1, the file management module 140 may cause a set of classification tags associated with the first file to be presented to a user on a display screen. In some implementations, the user may also be presented with any text portions that were used to identify the subset of the classification rules 150 that are applicable.

Block 560 includes a determination about whether the user has approved the classification results. If it is determined at block 560 that the user has approved the classification results, then the process 500 continues to block 570, which includes performing the detected action. For example, referring to FIG. 1, the file management module 140 may determine that the user has indicated an approval of the classification metadata 180 generated during the classification of the first file, and may then cause the action that triggered the classification (e.g., an action to share the first file) to be performed. As shown, after block 570, the process 500 can return to block 510.

However, if it is determined at block 560 that the user has not approved the classification results, then the process 500 continues to block 580, which includes rejecting the detected action. For example, referring to FIG. 1, the file management module 140 may determine that the user has indicated a disapproval of the classification metadata 180 generated during the classification of the first file, and may then cause the action that triggered the classification to be rejected without being performed. As shown, after block 580, the process 500 can return to block 510.

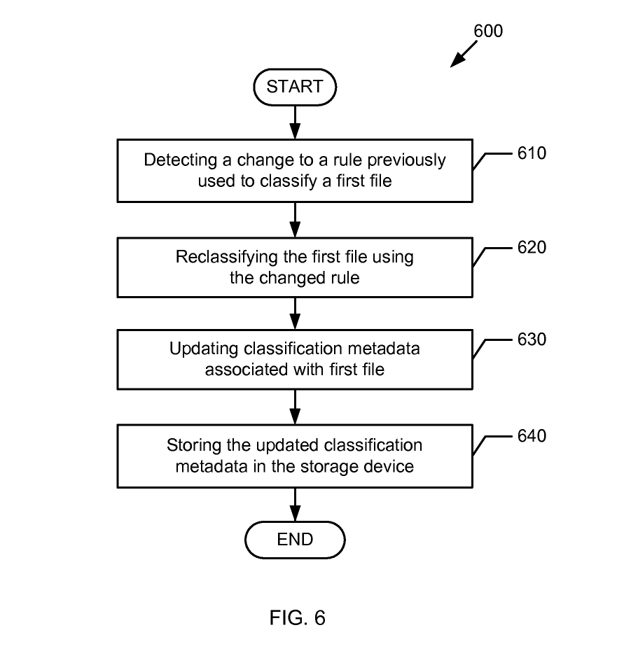

Referring now to FIG. 6, shown is a process 600 for reclassifying digital files, in accordance with some implementations. The process 600 may be performed by the processor(s) 110 and/or the file management module 140 shown in FIG. 1. The process 400 may be implemented in hardware or machine-readable instructions (e.g., software and/or firmware). The machine-readable instructions are stored in a non-transitory computer readable medium, such as an optical, semiconductor, or magnetic storage device. For the sake of illustration, details of the process 600 may be described below with reference to FIGS. 1-3, which show examples in accordance with some implementations. However, other implementations are also possible.

As shown, block 610 includes detecting a change to a rule previously used to classify a first file. For example, referring to FIG. 1, the file management module 140 may detect a change to a first rule of the classification rules 150, and may determine that the first rule was previously used to classify one of the classified files 170.

Block 620 includes reclassifying the first file using the changed rule. For example, referring to FIG. 1, the file management module 140 may reclassify the first file using the changed rule of the classification rules 150.

Block 630 includes updating the classification metadata associated with the first file. For example, referring to FIG. 1, the file management module 140 may generate new or revised classification tags when reclassifying the first file.

Block 640 includes storing the updated classification metadata in the storage device. For example, referring to FIG. 1, the file management module 140 may cause the updated classification tags to be stored or included in the classification metadata 180. In some implementations, the updated classification tags may be reviewed by the file owner. After block 640, the process 600 is completed.

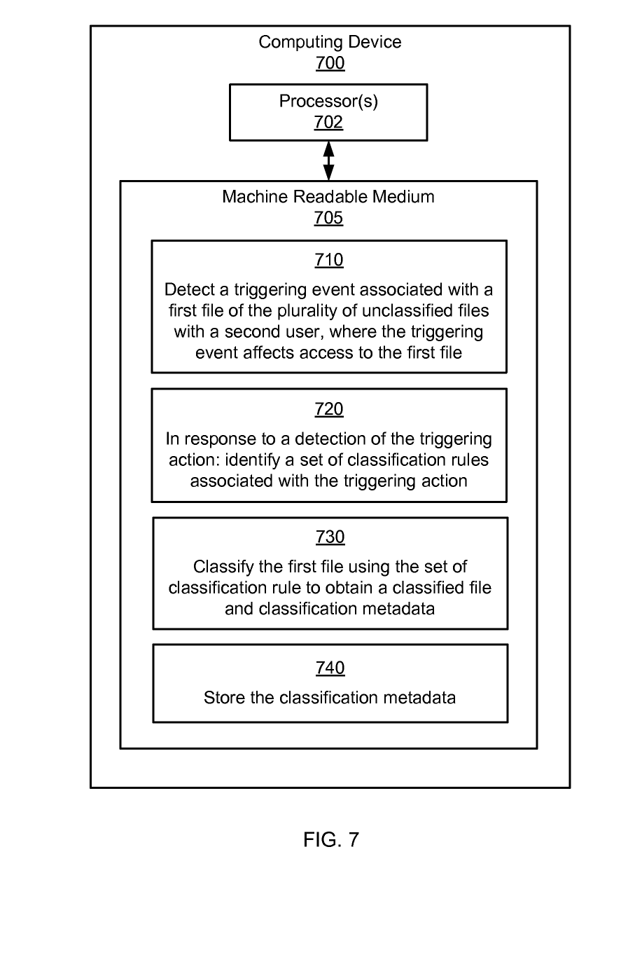

Referring now to FIG. 7, shown is a schematic diagram of an example computing device 700. In some examples, the computing device 700 may correspond generally to the computing device 100 shown in FIG. 1. As shown, the computing device 700 can include a hardware processor(s) 702 and machine-readable storage medium 705. The machine-readable storage medium 705 may store instructions 710-740. The instructions 710-740 can be executed by the hardware processor(s) 702.

As shown, instruction 710 may detect a triggering event associated with a first file of the plurality of unclassified files with a second user, where the triggering event affects access to the first file of the plurality of unclassified files. Instruction 720 may, in response to a detection of the action: identify a set of classification rules associated with the triggering action. Instruction 730 may classify the first file using the set of classification rule to obtain a classified file and classification metadata. Instruction 740 may store the classification metadata.

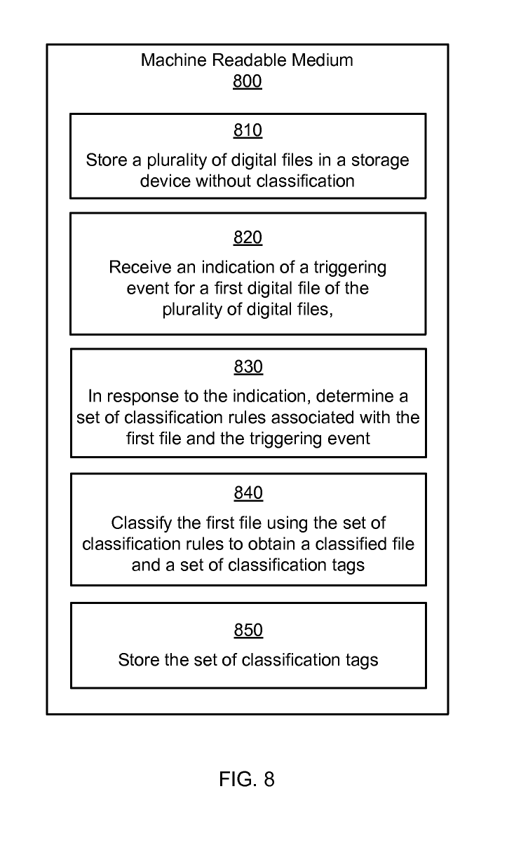

Referring now to FIG. 8, shown is a machine-readable storage medium 800 storing instructions 810-860, in accordance with some implementations. The instructions 810-860 can be executed by any number of processors (e.g., the processor(s) 110 shown in FIG. 1). The machine-readable storage medium 800 may be any non-transitory computer readable medium, such as an optical, semiconductor, or magnetic storage device.

As shown, instruction 810 may store a plurality of digital files in a storage device without classification. Instruction 820 may receive an indication of a triggering event for a first digital file of the plurality of digital files. Instruction 830 may, in response to the indication, determine a set of classification rules associated with the first file and the triggering event. Instruction 850 may classify the first file using the set of classification rules to obtain a classified file and a set of classification tags. Instruction 860 may store the set of classification tags.

In accordance with some implementations, techniques or mechanisms are provided for dynamic classification of digital files. Some implementations include storing all digital files in unclassified form. The classification of each file may be deferred until a triggering event occurs. The classified file and the resulting classification tags can be stored together. In some implementations, the dynamic classification of digital files may reduce storage space and processing loads.

Data and instructions are stored in respective storage devices, which are implemented as one or multiple computer-readable or machine-readable storage media. The storage media include different forms of non-transitory memory including semiconductor memory devices such as dynamic or static random access memories (DRAMs or SRAMs), erasable and programmable read-only memories (EPROMs), electrically erasable and programmable read-only memories (EEPROMs) and flash memories; magnetic disks such as fixed, floppy and removable disks; other magnetic media including tape; optical media such as compact disks (CDs) or digital video disks (DVDs); or other types of storage devices.

Note that the instructions discussed above can be provided on one computer-readable or machine-readable storage medium, or can be provided on multiple computer-readable or machine-readable storage media distributed in a large system having possibly plural nodes. Such computer-readable or machine-readable storage medium or media is (are) considered to be part of an article (or article of manufacture). An article or article of manufacture can refer to any manufactured single component or multiple components. The storage medium or media can be located either in the machine running the machine-readable instructions, or located at a remote site from which machine-readable instructions can be downloaded over a network for execution.

In the foregoing description, numerous details are set forth to provide an understanding of the subject disclosed herein. However, implementations may be practiced without some of these details. Other implementations may include modifications and variations from the details discussed above. It is intended that the appended claims cover such modifications and variations.

What is claimed is:

1. A computing device comprising:
a hardware processor; and
a machine-readable storage medium storing instructions, the instructions executable by the hardware processor to:
detect a triggering event associated with a first file of a plurality of unclassified files, wherein the triggering event affects access to the first file of the plurality of unclassified files;
in response to a detection of the triggering event:
identify a set of classification rules associated with the triggering event;
classify the first file using the set of classification rule to obtain a classified file and classification metadata; and
store the classification metadata.

2. The computing device of claim 1, wherein at least one classification rule of the set of classification rules is triggered by a first text portion of the first file.

3. The computing device of claim 2, wherein the classification metadata includes a set of classification tags and the first text portion.

4. The computing device of claim 3, wherein the classification metadata includes an encrypted form of the first text portion.

5. The computing device of claim 2, the instructions further executable to, in response to a modification to the at least one classification rule:
reclassify the first file using the modified at least one classification rule to obtain a reclassified file and revised classification metadata; and
store the revised classification metadata.

6. The computing device of claim 1, the instructions further executable to:
identify the set of classification rules based at least in part on an email domain of a user receiving access to the first file of the plurality of unclassified files.

7. The computing device of claim 1, the instructions further executable to:
classify asynchronously based on available processing capacity.

8. A method comprising:
storing a plurality of unclassified files in a storage device, wherein the plurality of unclassified files are owned by a first entity;
in response to a first action to share a first file of the plurality of unclassified files with a second entity:
determining a set of classification rules applicable to the second entity;
classifying the first file using the set of classification rules to obtain a classified file and a set of classification tags; and
storing the set of classification tags in the storage device.

9. The method of claim 8, further comprising:
detecting a triggering event associated with a second file of the plurality of unclassified files, wherein the triggering event affects access to the second file of the plurality of unclassified files;
in response to the triggering event:
determining a second set of classification rules applicable to the triggering event;
classifying the second file using the second set of classification rules to obtain a second classified file and a second set of classification tags; and
storing the second set of classification tags in the storage device.

10. The method of claim 8, further comprising determining an email domain of the second entity.

11. The method of claim 8, further comprising:
providing the classification metadata to the first entity; and
performing the first action only when the first entity approves the classification metadata.

12. An article comprising a machine-readable storage medium storing instructions that upon execution cause a processor to:
store a plurality of digital files in a storage device, wherein the plurality of digital files are stored without classification;
receive an indication of a triggering event for a first digital file of the plurality of digital files;
in response to the indication, determine a set of classification rules associated with the first file and the triggering event;
classify the first file using the set of classification rules to obtain a classified file and a set of classification tags; and
store the set of classification tags.

13. The article of claim 12, wherein the instructions further cause the processor to, in response to a modification to the set of classification rules:
reclassify the first digital file using the modified set of classification rules to obtain a reclassified file and an updated set of classification tags; and
store the updated set of classification tags.

14. The article of claim 12, wherein the instructions further cause the processor to:
encrypt a text portion of the first file, wherein at least one rule of the set of classification rules is triggered by the text portion; and
store the encrypted text portion with the classified file and the set of classification tags.

15. The article of claim 14, wherein the instructions further cause the processor to:
determine the set of classification rules based on a set of policy rules.
